(19) United States
(12) Patent Application Publication
(10) Pub. No.: US 2024/0157478 A1
(43) Pub. Date: May 16, 2024

(54) HIGH-SPEED STEEL SINTERED BODY AND METHOD OF MANUFACTURING HIGH-SPEED STEEL SINTERED BODY

(71) Applicant: Sumitomo Electric Sintered Alloy, Ltd., Takahashi-shi, Okayama (JP)

(72) Inventors: Takanori OOTAKI, Takahashi-shi, Okayama (JP); Hiroaki MOTOYAMA, Takahashi-shi, Okayama (JP)

(73) Assignee: Sumitomo Electric Sintered Alloy, Ltd., Takahashi-shi, Okayama (JP)

(21) Appl. No.: 18/281,308

(22) PCT Filed: Dec. 23, 2021
(86) PCT No.: PCT/JP2021/048038

§ 371 Date: Sep. 11, 2023

(30) Foreign Application Priority Data
Mar. 12, 2021 (WO) PCT/JP2021/010160

(51) Int. Cl. B23K 26/342; B22F 3/105; B22F 7/06; B22F 7/08; B22F 10/25; B22F 10/28; B23K 103/04; B33Y 10/00; B33Y 70/00; B33Y 80/00; C21D 1/18; C22C 38/04; C22C 38/24; C22C 38/26

(52) U.S. Cl. CPC B23K 26/342; B22F 3/105; B22F 7/08; B22F 10/25; B22F 10/28; C21D 1/18; C22C 38/04; C22C 38/24; C22C 38/26; B22F 2007/068; B22F 2202/11; B22F 2998/10; B22F 2999/00; B23K 2103/04; B33Y 10/00; B33Y 70/00; B33Y 80/00; C21D 2211/008

(57) ABSTRACT

A high-speed steel sintered body includes, a base, a solidified layer continuously disposed on a surface of the base. The base is constituted by high-speed steel, the solidified layer is constituted by high-speed steel whose composition is different from a composition of the high-speed steel constituting the base, and a boundary between the base and the solidified layer is not visually identified in a 200× magnified observation image of a section intersecting the surface.

The present disclosure relates to a high-speed steel sintered body and a method of manufacture a high-speed steel sintered body. This application claims priority based on International Application PCT/JP2021/10160 filed on Mar. 12, 2021, and the entire contents of the International Application are incorporated herein by reference.

### TECHNICAL FIELD

### Background

PTL 1 discloses a method of manufacturing a mold part. The method of manufacturing the mold part includes forming a cladding portion on a first surface of a base of the mold part. In the forming a cladding portion, spreading the powder in a layer on the first surface of the base and forming a layer obtained by melting and solidifying the layer of the powder by irradiating the layer of the powder with a laser are repeated. By repeating this, the cladding portion is constituted by a plurality of stack solidified layers. The base is constituted by die steel. The powder is constituted by SUS420J2.

### PRIOR ART DOCUMENT

### Patent Literature

PTL 1: WO 2018/225803

### SUMMARY

A high-speed steel sintered body of the present disclosure includes, a base, a solidified layer continuously disposed on a surface of the base. The base is constituted by high-speed steel, the solidified layer is constituted by high-speed steel whose composition is different from a composition of the high-speed steel constituting the base, and a boundary between the base and the solidified layer is not visually identified in a 200× magnified observation image of a section intersecting the surface.

A method of manufacturing a high-speed steel sintered body of the present disclosure includes, forming a cladding portion constituted by high-speed steel on a base constituted by high-speed steel. The forming a cladding portion includes repeating forming a powder layer and irradiating the powder layer with a laser beam to stack solidified layers each being formed as a result of solidification of the powder layer, the forming a powder layer includes spreading powder constituted by high-speed steel over a first surface, the first surface being a surface of the base or a surface of each of the solidified layers, and the irradiating with a laser beam is performed with a temperature of the first surface being raised to 130° C. or higher.

### BRIEF DESCRIPTION OF THE DRAWINGS

FIG. 1 is an explanatory diagram of a high-speed steel sintered body according to embodiment 1.

FIG. 2A is an enlarged photograph showing an example of an area A in FIG. 1 and an enlarged photograph showing a cross-section of the solidified layer in Sample No. 1.

FIG. 2B is an enlarged photograph showing an example of an area B in FIG. 1, and is an enlarged photograph showing a cross-section in the vicinity of the junction between the base and the solidified layer in Sample No. 1.

FIG. 2C is an enlarged photograph showing an example of an area C in FIG. 1 and an enlarged photograph showing a cross-section of the base in Sample No. 1.

FIG. 3 is a cross-sectional view showing a method of manufacturing a high-speed steel sintered body.

FIG. 4 is a cross-sectional view schematically showing a cladding portion formed by the method of manufacturing a high-speed steel sintered body.

FIG. 5 is a graph showing the relationship between the height of the powder layer and the height of the formed object and the energy density of the laser beam.

FIG. 6 is an enlarged photograph showing a cross-section in the vicinity of the boundary between the base and the solidified layer in Sample No. 101.

FIG. 7 is an enlarged photograph showing a cross-section in the vicinity of the boundary between the base and the solidified layer in Sample No. 112.

### DETAILED DESCRIPTION

### Problems to be Solved by Present Disclosure

It is desirable to form a solidified layer, and thus a cladding portion, constituted by high-speed steel on a base constituted by high-speed steel. However, an optimal manufacturing method of forming a solidified layer and thus the cladding portion formed on the base without causing cracks between the base constituted by high-speed steel and the solidified layer constituted by high-speed steel has not been studied.

An object of the present disclosure is to provide a high-speed steel sintered body in which cracks do not easily occur between a base and a solidified layer. It is an object of the present disclosure to provide a method of manufacturing a high-speed steel sintered body in which a cladding portion constituted by high-speed steel can be formed on a base constituted by high-speed steel without causing cracks.

### Advantageous Effects of Present Disclosure

The high-speed steel sintered body of the present disclosure is resistant to cracking between the base and the solidified layer.

The method of manufacturing a high-speed steel sintered body of the present disclosure can form a cladding portion constituted by high-speed steel on a base constituted by high-speed steel without cracking.

### Description of Embodiments of Present Disclosure

First, embodiments of the present disclosure will be listed and explained.

(1) A high-speed steel sintered body according to an aspect of present disclosure includes, a base, a solidified layer continuously disposed on a surface of the base. The base is constituted by high-speed steel, the solidified layer is constituted by high-speed steel whose composition is different from a composition of the high-speed steel constituting the base, and a boundary between the base and the solidified layer is not visually identified in a 200× magnified observation image of a section intersecting the surface.

Although the high-speed steel sintered body is constituted by high-speed steel in which the base and the solidified layer have different compositions, the boundary is not visually identified. That is, although the high-speed steel sintered body is constituted by high-speed steel in which the base and the solidified layer have different compositions, the base and the solidified layer are well compatible with each other. Therefore, in the high-speed steel sintered body, cracks are less likely to occur between the base and the solidified layer. The high-speed steel sintered body is suitable for mold parts and the like.

(2) As an aspect of the high-speed steel sintered body, no crack may be present between the base and the solidified layer.

In the embodiment, since no crack is present as a starting point of fracture, fracture due to propagation of the crack is less likely to occur.

(3) As an aspect of the high-speed steel sintered body, the base may have a carbon content of 0.5 mass % to 0.9 mass %.

In the embodiment, since the base and the solidified layer are well compatible with each other, cracks hardly occur between the base and the solidified layer.

(4) As an aspect of the high-speed steel sintered body according to (3), the composition of the base may contain, in addition to carbon, any one of an element group (1) to an element group (3) below, with the balance being iron and inevitable impurities.

(1) 0.2 mass % to 4.0 mass % of vanadium, 3 mass % to 15 mass % of chromium, and 0.5 mass % to 4 mass % of molybdenum,
(2) 0.2 mass % to 1.0 mass % of manganese, 0.2 mass % to 4.0 mass % of vanadium, 3 mass % to 15 mass % of chromium, 0.5 mass % to 4 mass % of molybdenum, and more than 0 mass % and 2.5 mass % or less of silicon, and
(3) 0.2 mass % to 1.0 mass % of manganese, 0.2 mass % to 4.0 mass % of vanadium, 3 mass % to 15 mass % of chromium, 0.5 mass % to 4 mass % of molybdenum, 0.5 mass % to 5 mass % of tungsten, and more than 0 mass % and 2.5 mass % or less of silicon.

In the embodiment, the base and the solidified layer have good compatibility.

(5) As an aspect of the high-speed steel sintered body, the solidified layer may have a carbon content of 0.5 mass % to 1.5 mass %.

In the embodiment, since the base and the solidified layer are well compatible with each other, cracks hardly occur between the base and the solidified layer.

(6) As an aspect of the high-speed steel sintered body according to (5), the composition of the solidified layer may contain, in addition to carbon, more than 0 mass % and 1.0 mass % or less of manganese, 1 mass % to 3 mass % of vanadium, 3 mass % to 5.5 mass % of chromium, 4 mass % to 6 mass % of molybdenum, and 5 mass % to 7.5 mass % of tungsten, with the balance being iron and inevitable impurities.

In the embodiment, the base and the solidified layer have good compatibility.

(7) A method of manufacturing a high-speed steel sintered body according to an aspect of present disclosure includes, forming a cladding portion constituted by high-speed steel on a base constituted by high-speed steel. The forming a cladding portion includes repeating forming a powder layer and irradiating the powder layer with a laser beam to stack solidified layers each being formed as a result of solidification of the powder layer, the forming a powder layer includes spreading powder constituted by high-speed steel over a first surface, the first surface being a surface of the base or a surface of each of the solidified layers, and the irradiating with a laser beam is performed with a temperature of the first surface being raised to 130° C. or higher.

In the method of manufacturing the high-speed steel sintered body, the powder layer is irradiated with a laser beam in a state in which the temperature of the first surface is heated to 130° C. or higher, and thus the solidified layer constituted by the high-speed steel and the cladding portion may be formed on the base constituted by the high-speed steel without generating cracks. Therefore, the method of manufacturing a high-speed steel sintered body is suitable for a method of manufacturing a mold part.

(8) As an aspect of the method of manufacturing a high-speed steel sintered body, a martensitic transformation start temperature of the base may be equal to or higher than a martensitic transformation start temperature of the powder.

In the base, it is easy to form a solidified layer with no cracks, and thus a cladding portion.

(9) As an aspect of the method of manufacturing a high-speed steel sintered body, the base may have a carbon content of 0.5 mass % to 0.9 mass %.

The base in which the content of C satisfies the above range is likely to improve compatibility with the solidified layer. Therefore, a solidified layer with no cracks can be easily formed in this base.

(10) As an aspect of the method of manufacturing a high-speed steel sintered body, the powder may have a carbon content of 0.5 mass % to 1.5 mass %.

The powder in which the content of C satisfies the above range easily improves the compatibility with the base. Therefore, by using this powder, it is easy to form a solidified layer with no cracks on the base.

(11) As an aspect of the method of manufacturing a high-speed steel sintered body, in the irradiating with a laser beam, the temperature of the first surface may be equal to or higher than a martensitic transformation start temperature of the powder.

With the configuration, it is easy to form a solidified layer with no cracks.

(12) As an aspect of the method of manufacturing a high-speed steel sintered body, in the irradiating with a laser beam, the temperature of the first surface may be equal to or higher than a martensitic transformation finish temperature of the base.

With the configuration, it is easy to form a solidified layer with no cracks.

(13) As an aspect of the method of manufacturing a high-speed steel sintered body, in the irradiating with a laser beam, an energy density of the laser beam may be applied to the powder layer formed n-th is equal to or lower than an energy density of the laser beam applied to the powder layer formed (n−1)-th, and the powder layer formed n-th may be one of the powder layers formed second to last.

The configuration can easily improve the junction property between the base and the solidified layer formed first. In addition, the configuration easily improves the junction property between the solidified layers near the base. Therefore, the configuration easily improves the junction property between the base and the cladding portion.

(14) As an aspect of the method of manufacturing a high-speed steel sintered body, in the forming a powder layer, a height of the powder layer may be formed n-th is equal to or larger than a height of the powder layer formed (n−1)-th, and the powder layer formed n-th may be one of the powder layers formed second to last.

The configuration can easily improve the junction property between the base and the solidified layer formed first. Therefore, the configuration easily improves the junction property between the base and the cladding portion. In addition, in the above-described configuration, it is easy to reduce the number of times of repeating the forming a powder layer and the irradiating with a laser beam while suppressing a decrease in the junction property between the solidified layers, and thus it is easy to improve the productivity of the high-speed steel sintered body.

(15) As an aspect of the method of manufacturing a high-speed steel sintered body, the laser beam may have an output of more than 300 W.

A laser beam with an output more than 300 W tends to efficiently couple the powder layers.

### DETAILS OF EMBODIMENTS OF PRESENT DISCLOSURE

The details of embodiments of the present disclosure are set forth in the description below. The same reference numerals in the drawings denote the same components.

### Embodiment

### [High-Speed Steel Sintered Body]

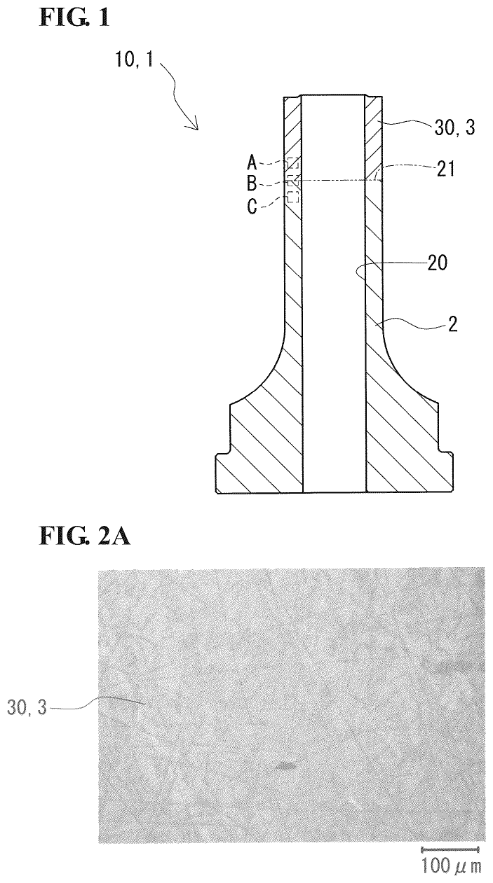

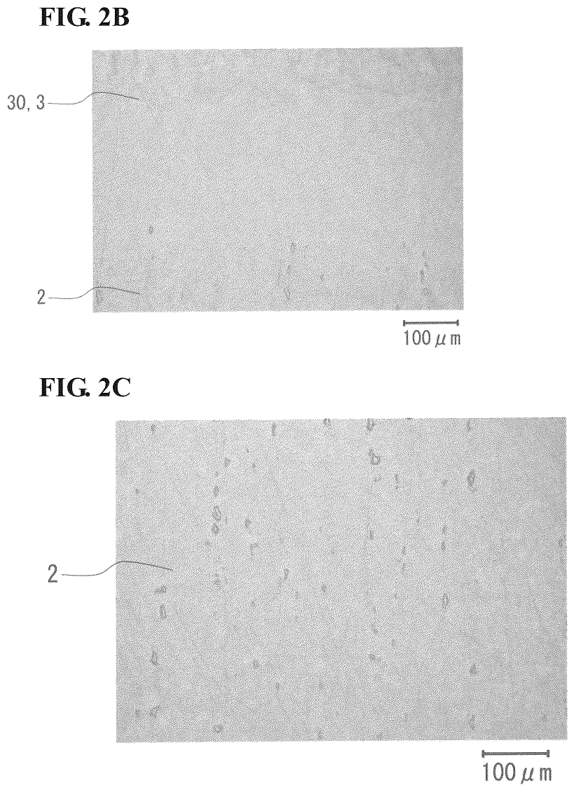

Referring to FIGS. 1 and 2A to 2C, an embodiment of a high-speed steel sintered body 1 will be described. High-speed steel sintered body 1 of the present embodiment includes a base 2 and a solidified layer 30. Solidified layer 30 constitute a cladding portion 3. In FIG. 1, base 2 illustrates a portion of a mold part 10. Solidified layer 30 is cladding portion 3 formed on a surface 21 of base 2 so as to extend base 2. Base 2 is constituted by high-speed steel. Solidified layer 30 is continuously provided on surface 21 of base 2. Solidified layer 30 is constituted by high-speed steel. One of the features of high-speed steel sintered body 1 of the present embodiment is that the boundary between base 2 and solidified layer 30 is not visually identified in a specific cross-sectional observation image even when base 2 and solidified layer 30 are constituted by high-speed steel having different compositions. Hereinafter, each configuration will be described in detail. The description below, high-speed steel sintered body 1 taken as an example of mold part 10.

[Base]

The shape of base 2 is not particularly limited. As in the embodiment when high-speed steel sintered body 1 is mold part 10, for example when mold part 10 is a punch, base 2 has a cylindrical shape as shown in FIG. 1 or a columnar shape (not shown). Base 2 shown in FIG. 1 is provided with through hole 20 along the longitudinal direction of base 2. A core rod (not shown) is penetrated through hole 20. Base 2 shown in FIG. 1, which is located on the upper side of the paper surface of FIG. 1, is fitted into a hole of a die (not shown). Surface 21 of base 2 located on the upper side of the paper surface of FIG. 1 has an annular shape. Although not shown, the shape of the surface of the cylindrical base is circular.

The material of base 2 is high-speed steel. The Ms point of base 2 is, for example, equal to or higher than the Ms point of solidified layer 30 to be described later. The Ms point refers to the martensitic transformation start temperature. That is, the Ms point of base 2 may be the same as or higher than the Ms point of solidified layer 30. Since the Ms point of base 2 is equal to or higher than the Ms point of solidified layer 30, no crack is present in solidified layer 30 on base 2. This is because it is easy to form solidified layer 30 and cladding portion 3 with no cracks in base 2 having the Ms point equal to or higher than the Ms point of solidified layer 30 in the manufacturing process. The Ms point of base 2 is, for example, 100° C. to 420° C., further 100° C. to 390° C., particularly 100° C. to 370° C. The Mf point of base 2 is, for example, 0° C. to 190° C., further 0° C. to 170° C., particularly 0° C. to 150° C. The Mf point is the martensitic transformation finish temperature. The Ms point of solidified layer 30 will be described later.

The composition of the high-speed steel constituting base 2 is, for example, any one of the following compositions (1) to (3).

(1) Containing C (carbon), V (vanadium), Cr (chromium), and Mo (molybdenum), with the balance being Fe (iron) and inevitable impurities.
(2) C, Mn (manganese), V, Cr, Mo, and Si (silicon), with the balance being Fe and inevitable impurities.
(3) C, Mn, V, Cr, Mo, W (tungsten), and Si, with the balance being Fe and inevitable impurities.

The content of C in base 2 is, for example, 0.5 mass % to 0.9 mass %. Base 2 in which the content of C satisfies the above range is excellent in compatibility with solidified layer 30. Therefore, cracks are less likely to be present in solidified layer 30 on base 2. This is because it is easy to form solidified layer 30 with no cracks in base 2 in which the content of C satisfies the range in the manufacturing process. The content of C in base 2 is further 0.55 mass % to 0.85 mass %, particularly 0.6 mass % to 0.8 mass %.

The contents of Mn, V, Cr, Mo, W, and Si in base 2 are, for example, as follows.

The content of Mn is, for example, 0.2 mass % to 1.0 mass %, further 0.2 mass % to 0.7 mass %, particularly 0.2 mass % to 0.5 mass %.
The content of V is, for example, 0.2 mass % to 4.0 mass %, further 0.2 mass % to 3.8 mass %, particularly 0.2 mass % to 3.5 mass %.
The content of Cr is, for example, 3 mass % to 15 mass %, further 3 mass % to 10 mass %, particularly 3 mass % to 6 mass %.
The content of Mo is, for example, 0.5 mass % to 4 mass %, further 0.5 mass % to 3.5 mass %, and particularly 1.0 mass % to 3.5 mass %.
The content of W is, for example, 0.5 mass % to 5 mass %, further 1.0 mass % to 4 mass %, and particularly 1.5 mass % to 3 mass % or less.
The content of Si is, for example, more than 0 mass % and 2.5 mass % or less, further 0.1 mass % to 2.0 mass %, particularly 0.2 mass % to 1.5 mass %.
When the content of each of Mn, V, Cr, Mo, W, and Si satisfies the above range, compatibility between base 2 and solidified layer 30 is good.

The composition of base 2 can be determined by analyzing a cross-section of base 2 by energy dispersive X-ray spectroscopy (EDX).

[Solidified Layer]

The shape of solidified layer 30 is not particularly limited. The shape of solidified layer 30 may be the same as the shape of base 2 or may be different from the shape of base 2. When mold part 10 is a punch as in the present embodiment, the shape of solidified layer 30 is, for example, the same shape as a part of base 2. Specifically, the shape of solidified layer 30 is cylindrical.

The material of solidified layer 30 is high-speed steel. The Ms point of solidified layer 30 is equal to or lower than the Ms point of base 2 as described above. The Ms point of solidified layer 30 is, for example, 100° C. to 300° C., further 100° C. to 250° C., and particularly 100° C. to 200° C. Further, the Mf point of solidified layer 30 is, for example, −110° C. to 180° C., further −100° C. to 165° C., particularly −90° C. to 150° C.

The composition of the high-speed steel constituting solidified layer 30 may be the same as or different from the composition of the high-speed steel constituting base 2. Even if the composition of base 2 and the composition of solidified layer 30 are different from each other, cracks are less likely to occur between base 2 and solidified layer 30 because base 2 and solidified layer 30 are fitted to each other to such an extent that a boundary between base 2 and solidified layer 30 is not visually identified as described later. For example, the composition of the high-speed steel constituting solidified layer 30 may be any one of the above-described compositions (1) to (3), or may be other than the above-described compositions (1) to (3). In addition to the above-described compositions (1) to (3), the composition of the high-speed steel constituting solidified layer 30 contains, for example, C, Mn, V, Cr, Mo, and W, with the balance being Fe and inevitable impurities.

The content of C in solidified layer 30 may be the same as or different from the content of C in base 2. The content of C in solidified layer 30 is, for example, 0.5 mass % to 1.5 mass %. Cracks are less likely to be present in solidified layer 30 in which the content of C satisfies the above range. This is because in the manufacturing process, when the content of C in the powder described below forming solidified layer 30 satisfies the above range, it is easy to form solidified layer 30 with no cracks. The content of C in solidified layer 30 is further 0.5% mass % to 1.2 mass %, particularly 0.5% mass % to 1.0 mass %.

When the composition of the high-speed steel constituting solidified layer 30 is any one of the above-described compositions (1) to (3), the contents of Mn, V, Cr, Mo, W, and Si in solidified layer 30 are as described above. When the composition of the high-speed steel constituting solidified layer 30 contains C, Mn, V, Cr, Mo, and W, the contents of Mn, V, Cr, Mo, and W in solidified layer 30 are, for example, as follows.

The content of Mn is, for example, more than 0 mass % and 1.0 mass % or less, further 0.1 mass % to 0.8 mass %, particularly 0.2 mass % to 0.5 mass %. The content of V is, for example, 1 mass % to 3 mass %, further 1.2 mass % to 2.8 mass %, particularly 1.5 mass % to 2.5 mass %. The content of Cr is, for example, 3 mass % to 5.5 mass %, further 3.5 mass % to 5 mass %, particularly 4.0 mass % to 4.8 mass %. The content of Mo is, for example, 4 mass % to 6 mass %, further 4.2 mass % to 5.7 mass %, and particularly 4.5 mass % to 5.5 mass %. The content of W is, for example, 5 mass % to 7.5 mass %, further 5.2 mass % to 7.2 mass %, and particularly 5.5 mass % to 7.0 mass %. When the content of each of Mn, V, Cr, Mo, and W satisfies the above range, compatibility between base 2 and solidified layer 30 is good.

The composition of solidified layer 30 can be determined by analyzing a cross-section of solidified layer 30 by EDX.

[Observation Image]

FIG. 2A is a photograph showing an example of a cross-section of solidified layer 30 in the high-speed steel sintered body of the present embodiment. FIG. 2B is a photograph showing an example of a cross-section of the high-speed steel sintered body in the vicinity of the junction between solidified layer 30 and base 2 in the high-speed steel sintered body of the present embodiment. FIG. 2C is a photograph showing an example of a cross-section of base 2. The cross-sections of FIGS. 2A to 2C are cross-sections intersecting surface 21 of base 2. Surface 21 is an area of the outer surface of base 2 to which solidified layer 30 is joined. The cross-section is a cross-section composed of a cutting plane spanning both base 2 and solidified layer 30. The photographs of FIGS. 2A to 2C are observation images observed by an optical microscope at a magnification of 200×. The upper portions of FIGS. 2A and 2B have a similar pattern. The upper portion of FIG. 2B and the lower portion of FIG. 2B have different patterns. The lower portion of FIG. 2B and FIG. 2C have the same pattern.

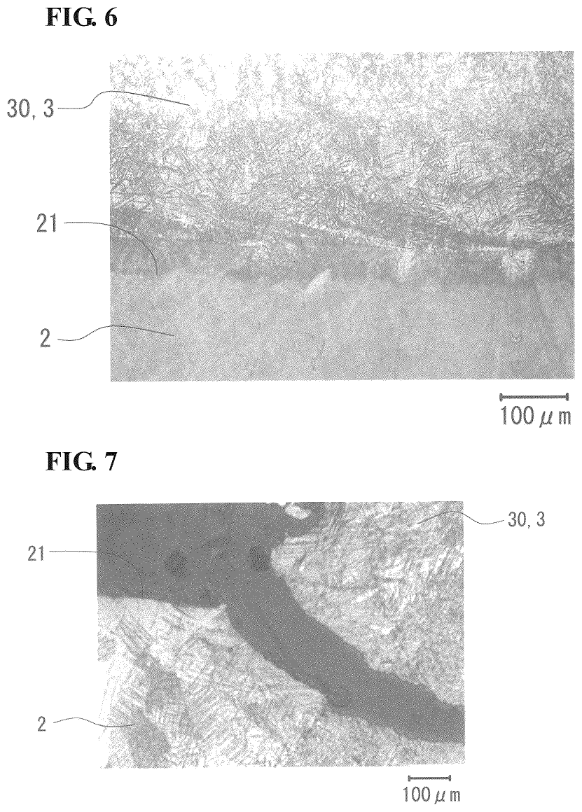

Specifically, in the pattern of the upper portion of FIGS. 2A and 2B, the granular portion as shown in FIG. 2C is not observed, and a plurality of thin lines intersect with each other. On the other hand, the lower portion of FIG. 2B and FIG. 2C have the same pattern. Specifically, the lower portion of FIG. 2B and the pattern of FIG. 2C are a pattern in which a plurality of granular portions are interspersed and a plurality of thin lines intersect each other. Both the granular portion and the plurality of thin line portions are carbides. From these pattern differences, it can be understood that a boundary between solidified layer 30 and base 2 exists between the upper portion and the lower portion of FIG. 2B. However, as shown in FIG. 2B, the boundary between solidified layer 30 and base 2 is not visually identified. The boundary mentioned here is a place where at least one of the composition and the structure changes. The term “not visually identified” used here is the line serving as the boundary is not visible when the photograph is visually observed. A photograph showing a visually identified boundary is shown in FIG. 6. FIG. 6 is a photograph showing a cross-section in the vicinity of a boundary between solidified layer 30 and base 2 in a high-speed steel sintered body of Sample No. 101 which is not the present embodiment and will be described later. The photograph of FIG. 6 is an observation image visually identified with an optical microscope at a magnification of 200× as in FIG. 2B. In FIG. 6, surface 21 of base 2, i.e., the boundary between solidified layer 30 and base 2, is visible as a boundary line. This boundary extends linearly in the left-right direction of the paper surface. As is clear from a comparison between FIG. 2B and FIG. 6, in the high-speed steel sintered body of the present embodiment shown in FIG. 2B, the boundary is not visually identified. That is, high-speed steel sintered body 1 has good compatibility between base 2 and solidified layer 30. Therefore, in high-speed steel sintered body 1, cracks are less likely to occur between base 2 and solidified layer 30. High-speed steel sintered body 1 is suitable for mold part 10 and the like.

When base 2 and solidified layer 30 are constituted by high-speed steel having different compositions, the composition of solidified layers 30 closer to base 2 is a gradient composition. This is because the components of base 2 diffuse to solidified layers 30 in the process of forming solidified layers 30. Specifically, a portion closer to base 2 in solidified layer 30 contains a larger amount of base 2 component. Therefore, the composition of a portion close to base 2 in solidified layer 30 is different from the composition of a portion far from base 2 in solidified layer 30. Between base 2 and solidified layer 30 joined to surface 21 of base 2 and between solidified layers 30 in cladding portion 3, a boundary is not visually identified in the observation image observed at a magnification of 200× as described above.

Further, as shown in FIG. 2B, no crack is present between base 2 and solidified layer 30 in high-speed steel sintered body 1 of the present embodiment. Since high-speed steel sintered body 1 has no cracks as a starting point of fracture, fracture due to crack propagation hardly occurs. A photograph of the presence of crack between base 2 and solidified layer 30 is shown in FIG. 7. FIG. 7 is a photograph showing a cross-section in the vicinity of a boundary between solidified layer 30 and base 2 in a high-speed steel sintered body of Sample No. 112 which is not the present embodiment and will be described later. The photograph of FIG. 7 is an observation image observed by an optical microscope at a magnification of 500×. In FIG. 7, a crack is present at the boundary between solidified layer 30 and base 2. The crack in FIG. 7 is the area shown in black between solidified layer 30 and base 2. In FIG. 7, the cracks are magnified 500× for clarity. From the size of the crack shown in FIG. 7, it is clear that the crack is recognized even in the observation image observed at a magnification of 200×. As is clear from a comparison between FIG. 2B and FIG. 7, the high-speed steel sintered body of the present embodiment shown in FIG. 2B has no cracks between base 2 and solidified layer 30. As shown in FIG. 2A, no crack is present in solidified layer 30 of the high-speed steel sintered body of this embodiment.

[Method of Manufacturing High-Speed Steel Sintered Body]

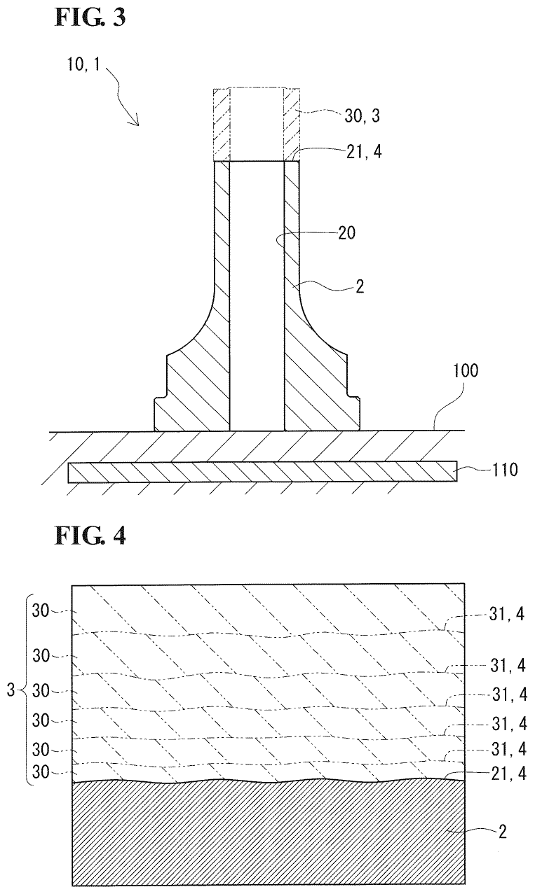

Referring to FIGS. 3 and 4, a method of manufacturing the high-speed steel sintered body of the present embodiment will be described. The method of manufacturing a high-speed steel sintered body according to the present embodiment includes forming cladding portion 3 on base 2. Base 2 is constituted of high-speed steel. In the forming cladding portion 3, the forming a powder layer and the irradiating the powder layer with a laser beam are repeated to stack solidified layer 30 in which the powder layers are bonded to each other as two dot chain line in FIG. 4. The forming a powder layer includes spreading powder made of high-speed steel on a first surface 4. First surface 4 is surface 21 of base 2 or a surface 31 of each of solidified layers 30. One of the features of the method of manufacturing a high-speed steel sintered body according to the present embodiment is that the irradiating with a laser beam is performed in a state where the temperature of first surface 4 is heated to a specific temperature. Hereinafter, each step will be described in detail. In the following description, a method of manufacturing a mold part will be described as an example of a method of manufacturing a high-speed steel sintered body of the present embodiment.

[Forming Cladding Portion]

In the forming cladding portion 3, the forming a powder layer and the irradiating the powder layer with a laser beam are repeated to stack solidified layer 30 in which the powder layer is bonded to base 2 as indicated by a two dot chain line in FIG. 4. The plurality of stacked solidified layers 30 constitute cladding portion 3. That is, mold part 10 in which base 2 and cladding portion 3 are joined to each other is manufactured through the forming cladding portion 3. The number of repetitions can be appropriately selected. When base 2 and cladding portion 3 are constituted by high-speed steels having different compositions, the components of base 2 diffuse to solidified layers 30 in the vicinity of the junction between base 2 and cladding portion 3 to form a gradient composition. A portion closer to surface 21 of base 2 in cladding portion 3 contains more base 2 components. The portion of cladding portion 3 far from surface 21 of base 2 has the same composition as that of the powder. Therefore, the difference between the composition of solidified layer 30 close to surface 21 of base 2 and the composition of solidified layer 30 far from surface 21 of base 2 becomes remarkable. A metal powder additive manufacturing apparatus can be used to form cladding portion 3. The metallic powder additive manufacturing apparatus is also called a metallic 3D printer.

[Base]

Base 2 is the second mold part. The second mold part is a used mold part in which a part of the first mold part is worn. The first mold part is a component constituting a mold for powder metallurgy used for compression molding of a raw material powder. The first mold part is a mold part in an initial state or in a state corresponding to the initial state. The mold part in the initial state is an unused mold part. The mold part in the initial state is a sintered body constituted by high-speed steel. The material of the mold part in the initial state is the same as the material of base 2 described above. The mold part in a state corresponding to the initial state is mold part 10 manufactured by the method of manufacturing a high-speed steel sintered body of the present embodiment. The portion indicated by the solid line in FIG. 3 is the second mold part. The first mold part is a combination of the portion indicated by the solid line and the portion indicated by the two dot chain line in FIG. 3. The first mold part is, for example, a punch as shown in FIG. 3 or a die (not shown). For example, when the first mold part is a punch, an end surface of the punch is worn by compression molding of the raw material powder. The first mold part in this worn condition is base 2. That is, the length of base 2 is shorter than the length of the first mold part. The length of base 2 depends on the length of the size of the mold for powder metallurgy, is for example, 50 mm to 200 mm, further 50 mm to 150 mm, particularly 50 mm to 100 mm.

The shape of base 2 is the same as the shape of base 2 described above. The material of base 2 is the same as the material of base 2 described above. Since the material of base 2 is the same as the material of base 2 described above, it is easy to form solidified layer 30 with no cracks and cladding portion 3 with respect to base 2.

[Forming Powder Layer]

The forming a powder layer includes spreading the powder on first surface 4. First surface 4 is surface 21 of base 2 or surface 31 of each of solidified layers 30. For example, when the first mold part is a punch, surface 21 of base 2 is an end surface of the punch. As shown in FIG. 4, surface 31 of solidified layer 30 formed over surface 21 of base 2 is the surface opposite to surface 21 of base 2. How to spread the powder can be appropriately selected depending on the size of the powder and the height of the powder layer. For example, the powder may be spread so that individual particles constituting the powder form one powder layer without being stacked, or the powder may be spread so that the particles are stacked.

The material of the powder is the same as the material of solidified layer 30 described above. The composition of this powder is maintained at the composition of solidified layer 30. Since the material of the powder is the same as the material of solidified layer 30 described above, it is easy to form solidified layer 30 with no cracks and cladding portion 3 with respect to base 2.

The average particle diameter of the powder is, for example, 10 μm to 100 μm. The powder having an average particle diameter satisfying the above range is easy to handle and easy to form the powder layer and solidified layer 30. The average particle diameter of the powder is furthermore 20 μm to 60 μm, in particular 20 μm to 50 μm. The average particle diameter means a particle diameter at which a cumulative volume becomes 50% in a volume particle size distribution measured by a laser diffraction particle size distribution measuring apparatus.

The shape of the powder is preferably spherical. The powder is preferably, for example, a gas atomized powder produced by a gas atomizing method.

The height of the powder layer can be selected as appropriate. As the height of the individual powder layer is higher, the height of individual solidified layer 30 is higher. The height of individual solidified layers 30 will be lower than the height of the individual powder layers. This is because solidified layer 30 is formed by melting and then solidifying the powder layer. The height of each powder layer may be the same. The height of at least one powder layer may be different.

When the heights of the powder layers are different, for example, the following requirements may be satisfied. The requirement is that the height of the powder layer formed n-th is equal to or higher than the height of the powder layer formed (n−1)-th. The powder layer formed n-th is each of the powder layers formed second to last. That is, as the number of powder layers increases from the powder layer formed first to last, the height of the powder layer is set to be higher than or equal to the height of the previous powder layer. By satisfying this requirement, it is easy to improve the junction property between base 2 and solidified layer 30 formed first. Therefore, the junction property between base 2 and cladding portion 3 can be easily improved. In addition, since it is easy to reduce the number of times of repeating the forming a powder layer and the irradiating with a laser beam while suppressing a decrease in the junction property between solidified layers 30, it is easy to improve the productivity of mold part 10. When this requirement is satisfied, as shown in FIG. 4, the height of a certain solidified layer 30 is equal to or higher than the height of solidified layer 30 previous to the certain solidified layer 30.

As an example satisfying the above requirement, for example, the range in which the height of the powder layer is increased as the number of the powder layers increases may be all the powder layers formed first to last. Further, the range may be a plurality of continuous powder layers selected from the powder layers formed first to last. The plurality of successive powder layers selected is, for example, any one of the following three patterns.

In the first pattern, powder layers are selected from the layers formed first to m₁-th.

In the second pattern, powder layers are selected from the layers formed m₂-th to m₃-th.
In the third pattern, powder layers are selected from the layers formed m₁-th to last.
The powder layer formed m₁-th is an intermediate powder layer between the layer formed first and the layer formed last.
The powder layer formed m₂-th is an intermediate powder layer between the layer formed first and the layer formed m₃-th.
The powder layer formed m₃-th is an intermediate powder layer between the layer formed m₂-th and the layer formed last.

When the plurality of successive powder layers are the powder layers formed first to m₁-th, the heights of the powder layers are as follows. The heights of the powder layers formed first to m₁-th are increased as the number of layers increases. The heights of the powder layers formed (m₁+1)-th to last are the same as the height of the powder layer formed m₁-th.

When the plurality of successive powder layers are the powder layers formed m₂-th to m₃-th, the heights of the powder layers are as follows. The heights of the powder layers formed first to m₂-th are uniform. The heights of the powder layer formed (m₂+1)-th to m₃-th are higher than the height of the powder layer formed m₂-th, and increases as the number of layers increases. The heights of the powder layers formed (m₃+1)-th to last are the same as the height of the powder layer formed m₃-th.

When the plurality of successive powder layers are the powder layers formed m₁-th to last, the heights of the powder layers are as follows. The heights of the powder layers formed first to m₁-th are uniform. The heights of the powder layers formed (m₁+1)-th to last are higher than the height of the powder layer formed m₁-th, and increase as the number of layers increases.

Here, “the heights of the powder layer are uniform” and “the heights of the powder layer are the same” refer to a case where the increase rate in the heights of the powder layers described later is less than 3.0%. That is, when the increase rate is 3.0% or more, it is said that “the heights of the powder layers increase”. The increase rate is represented by {(t_{A}-t_{A-1})/t_{A-1}}×100. t_{A} is the height of a certain powder layer. t_{A}−1 is the height of the powder layer previous to the certain powder layer. Preferably, the increase rate in the heights of the powder layers gradually decreases as the number of layers increases.

Depending on the total number of the stacked powder layer, the powder layer formed m₁-th is, for example, one of the layers formed (⅕ of the total number of stacked layers)-th to (½ of the total number of stacked layers)-th. For example, when the total number of stacked layers is 30, the powder layer formed m₁-th is one of the powder layers formed 6th to 15th. Further, depending on the total number of the stacked powder layers, the layer formed m₂-th is, for example, one of the layers formed (⅕ of the total number of stacked layers)-th to (⅖ of the total number of stacked layers)-th. Depending on the total number of the stacked powder layers, the layer formed m₃-th is, for example, one of the layers formed (⅗ of the total number of stacked layers)-th to (⅘ of the total number of stacked layers)-th. For example, when the total number of stacked layers is 30, the powder layer of the powder layer formed m₂-th is one of the layers formed 6th to 12th, and the powder layer formed m₃-th is one of the layers formed 18th to 24th.

The height of each powder layer is, for example, 0.02 mm to 0.08 mm, further 0.03 mm to 0.07 mm, in particular 0.04 mm to 0.05 mm.

[Irradiating Laser Beam]

In the irradiating the powder layer with a laser beam, the powder layer is irradiated with a laser beam to form solidified layer 30 in which the powder layer is solidified. The laser beam scans over the powder layer. As the laser beam is scanned, the entire powder layer is irradiated with the laser beam. By the irradiation of the laser beam, the particles constituting the powder layer are melted and bonded to each other.

In this step, first surface 4 on which the powder layer is formed is heated to a temperature of 130° C. or higher. That is, when solidified layer 30 formed first is formed, surface 21 of base 2 is heated to a temperature of 130° C. or higher. When the second and subsequent solidified layers 30 are formed, surface 31 of solidified layer 30 on which the powder layer is formed is heated to 130° C. or higher. By irradiating the powder layer with a laser beam in a state where the temperature of first surface 4 is heated to 130° C. or higher, solidified layer 30 with no cracks can be formed. In other words, cladding portion 3 constituted by high-speed steel can be formed on base 2 constituted by high-speed steel. By the forming cladding portion 3, base 2 can be restored to the mold part in a state corresponding to the initial state. The restored mold part in a state corresponding to the initial state, i.e., mold part 10 manufactured by the method of manufacturing a high-speed steel sintered body according to the present embodiment has an improved wear state, and thus can be reused. Therefore, the method of manufacturing a high-speed steel sintered body according to the present embodiment can reduce the cost of mold part 10 as compared with the case where the mold part in the initial state is manufactured from the beginning. The temperature of first surface 4 is, for example, even more than 150° C., in particular more than 200° C. The upper limit of the temperature of first surface 4 is practically 300° C. That is, the temperature of first surface 4 is 130° C. to 300° C., further 150° C. to 300° C., and further 200° C. to 300° C. The temperature of first surface 4 can be measured by a temperature sensor. The temperature sensor is, for example, an infrared temperature sensor.

The heating of first surface 4 can be performed with a temperature control device. The temperature control device includes a heat source 110 and a temperature control unit that controls a heat generation state of heat source 110. Illustration of the temperature control unit is omitted. Heat source 110 is, for example, a resistance heating element or a flow path of a high-temperature fluid. The high-temperature fluid is, for example, steam. Heat source 110 is built in a table 100 on which base 2 is placed. Depending on the position of first surface 4 of solidified layer 30, it is preferable that the output of heat source 110 is gradually increased while the forming a powder layer and the irradiating with a laser beam are repeated. Whenever solidified layer 30 is stacked, the position of first surface 4 of solidified layer 30 moves away from table 100. Therefore, it is easy to increase the temperature of first surface 4 of solidified layer 30 to 130° C. or higher by gradually increasing the output of heat source 110.

The temperature of first surface 4 is, for example, equal to or higher than the Ms point of the powder. The temperature of first surface 4 is, for example, equal to or higher than the Mf point of base 2. The temperature of first surface 4 satisfies, for example, both the Ms point or higher of the powder and the Mf point or higher of base 2. When the temperature of first surface 4 satisfies at least one of the Ms point or higher of the powder and the Mf point or higher of base 2, it is easy to form solidified layer 30 with no cracks.

The energy density of the laser beam is not particularly limited as long as the powder layer can be bonded, and can be appropriately selected. The energy density of the laser beam refers to an amount of energy input per unit volume in an irradiation area of the laser beam. The energy density of the laser beam is a value calculated by E=P/(v×s×t). E is the energy density (J/mm³) of the laser beam. P is the output (W) of the laser beam. V is a scanning speed (mm/s) of the laser beam. S is a scanning pitch (mm) of the laser beam. T is the height (mm) of the powder layer.

The energy density of the laser beam irradiated to each powder layer may be the same. The energy density of the laser beam irradiated to at least one powder layer may be different from the energy density of the laser beam irradiated to another powder layer.

When the energy densities of the laser beams are different, for example, the following requirements may be satisfied. The requirement is that the energy density of the laser beam applied to the powder layer formed n-th is equal to or less than the energy density of the laser beam applied to the powder layer formed (n−1)-th. The height of the powder layer formed n-th is the same as that of the powder layer formed n-th described above. That is, as the number of powder layers increases from the powder layer formed first to last, the energy density of the laser beam applied to the powder layer is set to be equal to or less than the energy density of the laser beam applied to the previous powder layer. By satisfying this requirement, it is easy to improve the junction property between base 2 and solidified layer 30 formed first. In addition, it is easy to improve the junction property between solidified layers 30 of base 2. Therefore, the junction property between base 2 and cladding portion 3 can be easily improved.

As an example of satisfying the above requirement, for example, the range in which the energy density of the laser beam is reduced as the number of powder layers increases is set to all the powder layers formed first to last. Further, the range may be a plurality of successive powder layers selected from the powder layers formed first to last. The plurality of successive powder layers selected is any one of the three patterns described in the description of the powder layer height. The meaning of the layers formed m₁-th to m₃-th is the same as that described in the description of the height of the powder layer.

When the plurality of successive powder layers are the powder layers formed first to m₁-th, the energy density of the laser beam is as follows. The energy density of the laser beam applied to the powder layers formed first to m₁-th is reduced as the number of layers increases. The energy density of the laser beam applied to the powder layers formed (m₁+1)-th to last is the same as the energy density of the laser beam applied to the powder layer formed m₁-th.

When the plurality of successive powder layers are the powder layers formed m₂-th to m₃-th, the energy density of the laser beam is as follows. The energy density of the laser beam applied to the powder layers formed first to m₂-th is uniform. The energy density of the laser beam applied to the powder layers formed (m₂+1)-th to m₃-th is less than the energy density of the laser beam applied to the powder layer formed m₂-th, and decreases as the number of layers increases. The energy density of the laser beam applied to the powder layers formed (m₃+1)-th to last is the same as the energy density of the laser beam applied to the powder layer formed m₃-th.

When the plurality of successive powder layers are the powder layers formed m₁-th to last, the energy density of the laser beam is as follows. The energy density of the laser beam applied to the powder layers formed first to m₁-th is uniform. The energy density of the laser beam applied to the powder layers formed (m₁+1)-th to last is less than the energy density of the laser beam applied to the powder layer formed m₁-th, and decreases as the number of layers increases.

Here, “the energy density of the laser beam is uniform” and “the energy density of the laser beam is the same” refer to a case where a decrease rate in the energy density of the laser beam described later is less than 7.5%. That is, when the decrease rate is 7.5% or more, the energy density of the laser beam is decreased. The decrease rate is represented by an absolute value of {(E_{A}−E_{A-1})/E_{A-1}}×100. E_{A} is the energy density of a laser beam applied to the powder layer of a certain layer. E_{A-1} is the energy density of a laser beam applied to the powder layer previous to the certain layer. It is preferable that the decrease rate in the energy density of the laser beam gradually decreases as the number of layers increases.

The energy density of the laser beam is, for example, 10 J/mm³ to 300 J/mm³. A laser beam having an energy density equal to or more than 10 J/mm³ can easily form solidified layer 30 with no cracks. The laser beam having an energy density equal to or less than 300 J/mm³ may prevent the powder layer from being excessively melted. Therefore, solidified layer 30 can be easily formed and the shape accuracy of solidified layer 30 can be easily maintained. The energy density of the laser beam is furthermore 10 J/mm³ to 200 J/mm³, in particular 10 J/mm³ to 180 J/mm³.

The output of the laser beam is, for example, more than 300 W. A laser beam with an output more than 300 W tends to efficiently couple the powder layers. The output of the laser beam is furthermore more than 350 W, in particular more than 400 W. The upper limit of the output of the laser beam is, for example, equal to or less than the 550 W. The laser beam having the output equal to or less than the 550 W can prevent the powder layer from being excessively melted. That is, the output of the laser beam is more than 300 W and 550 W or less, further 350 W to 520 W, particularly 400 W to 500 W. The output of the laser beam irradiated to each powder layer may be the same. The output of the laser beam irradiated to at least one powder layer may be different from the output of the laser beam irradiated to another powder layer.

The scanning speed of the laser beam is, for example, 300 mm/s to 1000 mm/s. When the scanning speed of the laser beam is 300 mm/s or more, the powder layer can be sufficiently melted. When the scanning speed of the laser beam is 1000 mm/s or less, the powder layer can be prevented from being excessively melted. The scanning speed of the laser beam is furthermore 320 mm/s to 800 mm/s, in particular 350 mm/s to 700 mm/s. The scanning speed of the laser beam irradiated to each powder layer may be the same. The scanning speed of the laser beam irradiated to at least one powder layer may be different from the scanning speed of the laser beam irradiated to another powder layer.

The scanning pitch of the laser beam is, for example, 0.05 mm to 0.3 mm. When the scanning pitch of the laser beam is 0.05 mm or more, the powder layer can be prevented from being excessively melted. When the scanning pitch of the laser beam is 0.3 mm or less, the entire powder layer can be sufficiently melted. The scanning pitch of the laser beam is furthermore 0.08 mm to 0.25 mm, in particular 0.1 mm to 0.2 mm.

The type of laser beam is, for example, a solid-state laser or a gas laser. The solid-state laser is, for example, a fiber laser or an yttrium aluminum garnet (YAG) laser. The fiber laser is preferable because a laser spot diameter can be reduced and a high output can be obtained. The fiber laser is, for example, an Yb fiber laser. The gas laser is, for example, a CO₂ laser.

[Pretreating]

The method of manufacturing a high-speed steel sintered body according to the present embodiment may include pretreating base 2 before the forming cladding portion 3. In the pretreatment, a predetermined area including a worn portion of base 2 is removed by machining to form first surface 4. For example, when the above-described first mold part is a punch, the predetermined area is an end portion with a predetermined length including a worn end surface. The end surface exposed by removing the predetermined area becomes first surface 4 having a small surface roughness. First surface 4 is preferably a flat surface. The surface roughness of first surface 4 is, for example, 1 μm or less in terms of maximum height roughness Rz according to JIS B 0601: 2013. The machining is, for example, machining such as milling, electric discharge machining such as wire cut, or grinding such as surface polishing.

[Post-Treating]

The method of manufacturing a high-speed steel sintered body according to the present embodiment may include post-treating cladding portion 3 after the forming cladding portion 3. The post-treatment is, for example, at least one of heat treatment and finish processing.

[Heat Treatment]

The heat treatment transforms the structure of cladding portion 3 and removes stress. The number of times of performing the heat treatment is, for example, plural times. Specifically, it is performed twice or three times.

After the laser irradiation, cladding portion 3 is cooled to room temperature. The process from laser irradiating to cooling corresponds to the quenching treatment. The cooling to room temperature is slow cooling. Therefore, at the time of cooling to room temperature, martensite and retained austenite are present in the structure of cladding portion 3. Therefore, the heat treatment is performed from the tempering treatment. The first heat treatment and the second heat treatment are tempering treatments. The first heat treatment transforms the retained austenite of cladding portion 3 to martensite. The second heat treatment can temper and stabilize the martensitic structure formed by the first heat treatment. By these tempering treatments, cladding portion 3 and base 2 can be made to have the same martensitic structure. Since cladding portion 3 and base 2 have the same martensite structures, the mechanical properties of entire mold part 10 can be homogenized.

The heating temperature of the tempering treatment is, for example, 530° C. to 630° C., further 540° C. to 620° C., and particularly 550° C. to 615° C. The holding time at the heating temperature is, for example, 1 hour to 4 hours, further 1 hour to 3 hours, particularly 1 hour to 2 hours. After holding, mold part 10 is cooled to a temperature below the Ms point of cladding portion 3.

The third heat treatment is a treatment for removing stress. The heating temperature is, for example, a temperature lower than the heating temperature of the tempering treatment by about 30° C. to 50° C. The heating temperature is 480° C. to 600° C. The holding time at the heating temperature is, for example, the same as the holding time in the tempering treatment. Mold part 10 is held at the heating temperature and then cooled to room temperature.

[Finish Processing]

The finishing process corrects the dimensional error of cladding portion 3. For example, when the first mold part is a punch, the finishing process is performed on the end surface, the outer circumferential surface and the inner circumferential surface of cladding portion 3. In this case, the end surface of cladding portion 3 constitutes a surface on which the raw material powder is compression-molded. The outer circumferential surface of cladding portion 3 is in sliding contact with the inner circumferential surface of the through hole of the die. The inner peripheral surface of cladding portion 3 is brought into sliding contact with the outer peripheral surface of the core rod. The finish processing is, for example, machining similar to the pretreatment. When the heat treatment is performed, the finish processing is performed, for example, after the heat treatment.

[Test]

### [Samples No. 1 to No. 3]

As samples No. 1 to No. 3, high-speed steel sintered bodies were manufactured in the same manner as in the method of manufacturing the high-speed steel sintered body of the above-described embodiment.

[Preparing]

A base and a powder were prepared. A cylindrical member was prepared as the base of each sample. The base of each sample is a sintered body constituted by high-speed steel. The composition of the high-speed steel constituting the base of each sample is different as shown in Table 1. “-” shown in Table 1 means that the element is not contained. In this example, the first surface was formed by cutting and removing the tip portion of the base in a direction perpendicular to the axial direction of the base with wire cut. Thereafter, the first surface of the base was subjected to surface grinding so that the maximum height roughness Rz of the first surface was 1 μm or less. The outside diameter of the first surface of the base is 23.96 mm and the inside diameter is 14.99 mm. The powder of each sample is constituted by high-speed steel. The composition of the high-speed steel constituting the powder of each sample was the same as shown in Table 2. The composition of the base and powder of each sample was determined with EDX.

The Ms point of the composition shown in Table 2 is a measured value based on a created TTT (Time-Temperature-Transformation) diagram. The Mf points of the compositions shown in Table 2 are values obtained at the Ms point −215° C. The Ms point of the composition shown in Table 1 is a value obtained at the calculated value +166° C. The calculated value is a value obtained based on an equation for estimating the Ms point from the composition described on page 103 of “Metal Engineering Series 1, Revised Constituent Metal Materials and Heat Treatment Thereof, 3rd edition published on Jun. 10, 1981 (partially revised)”. The above equation is Ms point (° C.)=550−350×(mass % of C)−40×(mass % of Mn)−35×(mass % of V)−20×(mass % of Cr)−17×(mass % of Ni)−10×(mass % of Mo)−10×(mass % of Cu)−10×(mass % of W)+15×(mass % of Co)−10×(mass % of Si) The temperature of 166° C. is determined as follows. The measured value of the Ms point of the composition shown in Table 2 is 135° C. The calculated value of the Ms point of the composition shown in Table 2 based on the above equation is −31° C. The difference between the measured value and the calculated value is 166° C. Therefore, this difference was added to the calculated value to obtain the Ms point of the composition shown in Table 1. The Mf point shown in Table 1 is a value obtained at the Ms point minus 215° C.

TABLE 1

| | BASE | | | | | | | | |
|---|---|---|---|---|---|---|---|---|---|
| | COMPOSITION | | | | | | | Ms | Mf |
| SAMPLE | C | Mn | V | Cr | Mo | W | Si | POINT | POINT |
| NO. | (MASS %) | (MASS %) | (MASS %) | (MASS %) | (MASS %) | (MASS %) | (MASS %) | (° C.) | (° C.) |
| 1 | 0.5 | — | 1.8 | 4.3 | 2.9 | — | — | 363 | 148 |
| 101 | | | | | | | | | |
| 111 | | | | | | | | | |
| 2 | 0.56 | 0.3 | 0.6 | 5 | 2.4 | — | 1.2 | 351 | 136 |
| 102 | | | | | | | | | |
| 112 | | | | | | | | | |
| 3 | 0.66 | 0.5 | 1.2 | 5.5 | 2.5 | 1 | 0.3 | 275 | 60 |
| 103 | | | | | | | | | |
| 113 | | | | | | | | | |

TABLE 2

| | POWDER | | | | | | | |
|---|---|---|---|---|---|---|---|---|
| | COMPOSITION | | | | | | Ms | Mf |
| SAMPLE | C | Mn | V | Cr | Mo | W | POINT | POINT |
| NO. | (MASS %) | (MASS %) | (MASS %) | (MASS %) | (MASS %) | (MASS %) | (° C.) | (° C.) |
| 1~3 | 0.88 | 0.35 | 1.77 | 4.12 | 4.97 | 6.5 | 135 | −80 |
| 101~103 | | | | | | | | |
| 111~113 | | | | | | | | |

[Forming Cladding Portion]

The forming a powder layer and the irradiating with a laser beam were repeated to laminate solidified layers in which the powder layers were solidified, thereby forming a cladding portion on the base. A metal 3D printer equipped with a temperature control device was used to form the cladding portion. OPM350 L printer manufactured by Sodick Co., Ltd. was used as a metal 3D printer. The heat source embedded in the table on which the base was placed was adjusted so that the temperature of the first surface of the base and the temperature of the first surface of each solidified layer can be heated to 130° C. or higher.

In this example, the number of times of repeating the forming a powder layer and the irradiating with a laser beam was 30 times. In this example, the irradiation of the powder layer formed first with a laser beam was performed in a state where the temperature of the first surface of the base was heated to 150° C. by the heat source. The powder layer formed second and the subsequent layers were irradiated with a laser beam in a state where the first surface of each solidified layer covered with each powder layer was heated to 150° C. by the heat source.

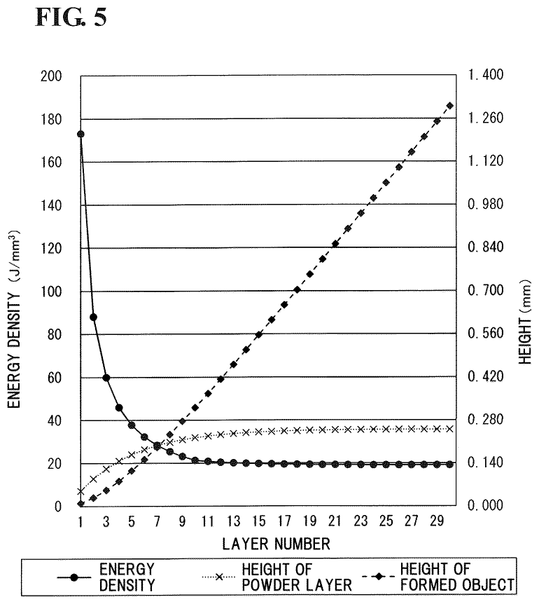

In this example, the powder layers formed first to 30th in each sample were spread so that the inner diameter of the solidified layer was the same as the inner diameter of the base and the outer diameter of the solidified layer was smaller than the outer diameter of the base. The height of each of powder layers formed first to 30th in each sample, the increase rate in the height of the powder layer, the height of the formed object, and the conditions of the laser beam are as shown in Table 3. The height of the formed object is the total height of the solidified layers. That is, the height of the formed object of the layer formed 30th is the height of the cladding portion. The conditions of the laser beam include an output, a scanning pitch, a scanning speed, an energy density, and a decrease rate in the energy density. The energy densities shown in Table 3 are rounded off to the nearest whole number. The increase rates in the height of the powder layer and the decrease rates in the energy density shown in Table 3 are rounded off to the first decimal place. The height of each of powder layers formed first to 30th, the height of the formed object, and the energy density of the laser beam in each sample are shown as a graph in FIG. 5. The horizontal axis of FIG. 5 is the layer number corresponding to the stacking order of each solidified layer. The vertical axis on the left side of FIG. 5 is the energy density (J/mm³) of the laser beam. The vertical axis on the right side of FIG. 5 is the height (mm) of the powder layer and the height (mm) of the formed object. The solid lines and the black circles in FIG. 5 indicate energy density. The dotted lines and the crosses in FIG. 5 indicate the height of the powder layer. The dashed line and the black diamond mark in FIG. 5 indicate the height of the formed object.

TABLE 3

| | POWDER LAYER | | FORMED | LASER BEAM | | | | |
|---|---|---|---|---|---|---|---|---|
| | | INCREASE | OBJECT | | SCANNING | SCANNING | ENERGY | DECREASE |
| LAYER | HEIGHT | RATE | HEIGHT | OUTPUT | PITCH | SPEED | DENSITY | RATE |
| NUMBER | (mm) | (%) | (mm) | (W) | (mm) | (mm/s) | (J/mm³) | (%) |
| 1 | 0.050 | — | 0.010 | 400 | 0.12 | 385 | 173 | — |
| 2 | 0.090 | 80.0 | 0.028 | 400 | 0.12 | 420 | 88 | 49.1 |
| 3 | 0.122 | 35.6 | 0.052 | 400 | 0.12 | 455 | 60 | 31.9 |
| 4 | 0.148 | 21.0 | 0.082 | 400 | 0.12 | 490 | 46 | 23.2 |
| 5 | 0.168 | 13.9 | 0.116 | 400 | 0.12 | 525 | 38 | 18.0 |
| 6 | 0.184 | 9.7 | 0.152 | 400 | 0.12 | 560 | 32 | 14.6 |
| 7 | 0.198 | 7.1 | 0.192 | 400 | 0.12 | 595 | 28 | 12.1 |
| 8 | 0.208 | 5.3 | 0.234 | 400 | 0.12 | 630 | 25 | 10.3 |
| 9 | 0.216 | 4.0 | 0.277 | 400 | 0.12 | 665 | 23 | 8.9 |
| 10 | 0.223 | 3.1 | 0.321 | 400 | 0.12 | 700 | 21 | 7.9 |
| 11 | 0.229 | 2.4 | 0.367 | 400 | 0.12 | 700 | 21 | 2.3 |
| 12 | 0.233 | 1.9 | 0.414 | 400 | 0.12 | 700 | 20 | 1.8 |
| 13 | 0.236 | 1.5 | 0.461 | 400 | 0.12 | 700 | 20 | 1.5 |
| 14 | 0.239 | 1.2 | 0.509 | 400 | 0.12 | 700 | 20 | 1.2 |
| 15 | 0.241 | 0.9 | 0.557 | 400 | 0.12 | 700 | 20 | 0.9 |
| 16 | 0.243 | 0.7 | 0.606 | 400 | 0.12 | 700 | 20 | 0.7 |
| 17 | 0.244 | 0.6 | 0.655 | 400 | 0.12 | 700 | 19 | 0.6 |
| 18 | 0.245 | 0.5 | 0.704 | 400 | 0.12 | 700 | 19 | 0.5 |
| 19 | 0.246 | 0.4 | 0.753 | 400 | 0.12 | 700 | 19 | 0.4 |
| 20 | 0.247 | 0.3 | 0.802 | 400 | 0.12 | 700 | 19 | 0.3 |
| 21 | 0.248 | 0.2 | 0.852 | 400 | 0.12 | 700 | 19 | 0.2 |
| 22 | 0.248 | 0.2 | 0.901 | 400 | 0.12 | 700 | 19 | 0.2 |
| 23 | 0.249 | 0.1 | 0.951 | 400 | 0.12 | 700 | 19 | 0.1 |
| 24 | 0.249 | 0.1 | 1.001 | 400 | 0.12 | 700 | 19 | 0.1 |
| 25 | 0.249 | 0.1 | 1.051 | 400 | 0.12 | 700 | 19 | 0.1 |
| 26 | 0.249 | 0.1 | 1.101 | 400 | 0.12 | 700 | 19 | 0.1 |
| 27 | 0.249 | 0.1 | 1.150 | 400 | 0.12 | 700 | 19 | 0.1 |
| 28 | 0.250 | 0.0 | 1.200 | 400 | 0.12 | 700 | 19 | 0.0 |
| 29 | 0.250 | 0.0 | 1.250 | 400 | 0.12 | 700 | 19 | 0.0 |
| 30 | 0.250 | 0.0 | 1.300 | 400 | 0.12 | 700 | 19 | 0.0 |

[Sample Nos. 101 to 103]

As Samples No. 101 to No. 103, metal parts were manufactured in the same manner as Samples No. 1 to No. 3 except that the temperature of the first surface of the base and the temperature of the first surface of each solidified layer were heated to 120° C. when each powder layer was irradiated with a laser beam.

[Sample Nos. 111 to 113]

As Sample Nos. 111 to 113, metal parts were manufactured in the same manner as in Sample Nos. 1 to 3 except that the first surface of the base and the first surface of each solidified layer were not heated when each powder layer was irradiated with a laser beam.
The temperatures of the first surface of the base and the first surface of each solidified layer were both room temperature, specifically 30° C.

[Presence or Absence of Crack in Cladding Portion]

The presence or absence of cracks in the cladding portion of the high-speed steel sintered body of each sample was visually examined.

As a representative example, a photograph of the cladding portion in the high-speed steel sintered body of Sample No. 1 is shown in FIG. 2A. As shown in FIG. 2A, no cracks were observed in the cladding portion of the high-speed steel sintered body of Sample No. 1. Although not shown, cracks were not observed in the cladding portions of the high-speed steel sintered bodies of Sample No. 2 and Sample No. 3, similarly to Sample No. 1. On the other hand, although not shown in the drawings, cracks were observed in the cladding portions of the high-speed steel sintered bodies of Sample Nos. 101 to 103 and Sample Nos. 111 to 113.

[Visual Identification of Boundary]

The boundary between the base layer and the solidified layer formed first in the high-speed steel sintered body of each sample was observed. As a representative example, FIG. 2B shows a photograph of the vicinity of the junction between the base and the solidified layer formed first in the high-speed steel sintered body of Sample No. 1, and FIG. 6 shows a photograph of the vicinity of the boundary in the high-speed steel sintered body of Sample No. 101.

As shown in FIG. 2B, in the high-speed steel sintered body of Sample No. 1, the boundary is not visually identified. Although not shown, in the high-speed steel sintered bodies of Sample No. 2 and Sample No. 3, the boundary is not visually identified as in Sample No. 1. On the other hand, as shown in FIG. 6, in the high-speed steel sintered body of Sample No. 101, the boundary can be visually identified. Although not shown, in the high-speed steel sintered bodies of Sample Nos. 102 and 103, the boundary can be visually identified as in Sample No. 101. Further, although not shown, the boundary can be visually identified in Sample Nos. 111 to 113.

[Presence or Absence of Crack in Junction]

The presence or absence of cracks at the junction between the base and the solidified layer in the high-speed steel sintered body of each sample was examined. As a representative example, FIG. 7 shows a photograph of the vicinity of the boundary in the high-speed steel sintered body of Sample No. 112.

Although not shown, cracks were not observed at the junction in the high-speed steel sintered bodies of Sample Nos. 1 to 3. On the other hand, as shown in FIG. 7, cracks were observed at the boundary in the high-speed steel sintered body of Sample No. 112. Although not shown, cracks were observed at the boundary in the high-speed steel sintered bodies of Sample Nos. 111 and 113 as in Sample No. 112. Further, although not shown, cracks were observed at the boundaries in the high-speed steel sintered bodies of Sample Nos. 101 to 103.

The present invention is not limited to these examples, but is defined by the scope of the claims, and is intended to include all modifications within the meaning and scope equivalent to the scope of the claims.

### REFERENCE SIGNS LIST

1 high-speed steel sintered body
10 mold part
2 base, 20 through hole, 21 surface
3 cladding portion, 30 solidified layer, 31 surface
4 first surface
100 table, 110 heat source

1. A high-speed steel sintered body comprising:
a base; and
a solidified layer continuously disposed on a surface of the base,
wherein the base is constituted by high-speed steel,
the solidified layer is constituted by high-speed steel whose composition is different from a composition of the high-speed steel constituting the base, and
a boundary between the base and the solidified layer is not visually identified in a 200× magnified observation image of a section intersecting the surface.

2. The high-speed steel sintered body according to claim 1, wherein no crack is present between the base and the solidified layer.

3. The high-speed steel sintered body according to claim 1,
wherein the base has a carbon content of 0.5 mass % to 0.9 mass %.

4. The high-speed steel sintered body according to claim 3, wherein the composition of the base contains, in addition to carbon, any one of an element group (1) to an element group (3) below, with the balance being iron and inevitable impurities,
(1) 0.2 mass % to 4.0 mass % of vanadium, 3 mass % to 15 mass % of chromium, and 0.5 mass % to 4 mass % of molybdenum,
(2) 0.2 mass % to 1.0 mass % of manganese, 0.2 mass % to 4.0 mass % of vanadium, 3 mass % to 15 mass % of chromium, 0.5 mass % to 4 mass % of molybdenum, and more than 0 mass % and 2.5 mass % or less of silicon, and
(3) 0.2 mass % to 1.0 mass % of manganese, 0.2 mass % to 4.0 mass % of vanadium, 3 mass % to 15 mass % of chromium, 0.5 mass % to 4 mass % of molybdenum, 0.5 mass % to 5 mass % of tungsten, and more than 0 mass % and 2.5 mass % or less of silicon.

5. The high-speed steel sintered body according to claim 1, wherein the solidified layer has a carbon content of 0.5 mass % to 1.5 mass %.

6. The high-speed steel sintered body according to claim 5, wherein the composition of the solidified layer contains, in addition to carbon, more than 0 mass % and 1.0 mass % or less of manganese, 1 mass % to 3 mass % of vanadium, 3 mass % to 5.5 mass % of chromium, 4 mass % to 6 mass % of molybdenum, and 5 mass % to 7.5 mass % of tungsten, with the balance being iron and inevitable impurities.

7. A method of manufacturing a high-speed steel sintered body, the method comprising:
forming a cladding portion constituted by high-speed steel on a base constituted by high-speed steel,
wherein the forming a cladding portion includes repeating forming a powder layer and irradiating the powder layer with a laser beam to stack solidified layers each being formed as a result of solidification of the powder layer,
the forming a powder layer includes spreading powder constituted by high-speed steel over a first surface, the first surface being a surface of the base or a surface of each of the solidified layers, and
the irradiating with a laser beam is performed with a temperature of the first surface being raised to 130° C. or higher.

8. The method of manufacturing a high-speed steel sintered body according to claim 7, wherein a martensitic transformation start temperature of the base is equal to or higher than a martensitic transformation start temperature of the powder.

9. The method of manufacturing a high-speed steel sintered body according to claim 7, wherein the base has a carbon content of 0.5 mass % to 0.9 mass %.

10. The method of manufacturing a high-speed steel sintered body according to claim 7, wherein the powder has a carbon content of 0.5 mass % to 1.5 mass %.

11. The method of manufacturing a high-speed steel sintered body according to claim 7, wherein in the irradiating with a laser beam, the temperature of the first surface is equal to or higher than a martensitic transformation start temperature of the powder.

12. The method of manufacturing a high-speed steel sintered body according to claim 7, wherein in the irradiating with a laser beam, the temperature of the first surface is equal to or higher than a martensitic transformation finish temperature of the base.

13. The method of manufacturing a high-speed steel sintered body according to claim 7, wherein in the irradiating with a laser beam, an energy density of the laser beam applied to the powder layer formed n-th is equal to or lower than an energy density of the laser beam applied to the powder layer formed (n−1)-th, and
the powder layer formed n-th is one of the powder layers formed second to last.

14. The method of manufacturing a high-speed steel sintered body according to claim 7, wherein in the forming a powder layer, a height of the powder layer formed n-th is equal to or larger than a height of the powder layer formed (n−1)-th, and
the powder layer formed n-th is one of the powder layers formed second to last.

15. The method of manufacturing a high-speed steel sintered body according to claim 7, wherein the laser beam has an output of more than 300 W.

16. The high-speed steel sintered body according to claim 2, wherein the base has a carbon content of 0.5 mass % to 0.9 mass %.

17. The high-speed steel sintered body according to claim 16, wherein the composition of the base contains, in addition to carbon, any one of an element group (1) to an element group (3) below, with the balance being iron and inevitable impurities,
(1) 0.2 mass % to 4.0 mass % of vanadium, 3 mass % to 15 mass % of chromium, and 0.5 mass % to 4 mass % of molybdenum,
(2) 0.2 mass % to 1.0 mass % of manganese, 0.2 mass % to 4.0 mass % of vanadium, 3 mass % to 15 mass % of chromium, 0.5 mass % to 4 mass % of molybdenum, and more than 0 mass % and 2.5 mass % or less of silicon, and
(3) 0.2 mass % to 1.0 mass % of manganese, 0.2 mass % to 4.0 mass % of vanadium, 3 mass % to 15 mass % of chromium, 0.5 mass % to 4 mass % of molybdenum, 0.5 mass % to 5 mass % of tungsten, and more than 0 mass % and 2.5 mass % or less of silicon.

18. The high-speed steel sintered body according to claim 2, wherein the solidified layer has a carbon content of 0.5 mass % to 1.5 mass %.

19. The high-speed steel sintered body according to claim 3, wherein the solidified layer has a carbon content of 0.5 mass % to 1.5 mass %.

20. The high-speed steel sintered body according to claim 4, wherein the solidified layer has a carbon content of 0.5 mass % to 1.5 mass %.
